(19) United States
(12) Patent Application Publication
(10) Pub. No.: US 2024/0105209 A1
(43) Pub. Date: Mar. 28, 2024

(54) DEVICE FOR CLASSIFYING SOUND SOURCE USING DEEP LEARNING, AND METHOD THEREFOR

(71) Applicant: HANYANG S&ACO., LTD., Seoul (JP)

(72) Inventors: Jin Yong JEON, Seoul (KR); Jun Hong PARK, Seoul (KR); Sang Heon KIM, Seoul (KR); Hyun LEE, Seoul (KR); Hyun In JO, Seoul (KR); Hong Pin ZHAO, Seoul (KR); Hyun Min KIM, Seoul (KR)

(73) Assignee: HANYANG S&A CO., LTD., Seoul (JP)

(21) Appl. No.: 18/273,592

(22) PCT Filed: Nov. 18, 2021
(86) PCT No.: PCT/KR2021/017019

§ 371 Date: Jul. 21, 2023

(30) Foreign Application Priority Data
Jan. 27, 2021 (KR) 10-2021-0011413

(51) Int. Cl. G10L 25/66; G06T 11/00; G10L 21/10

(52) U.S. Cl. CPC G10L 25/66; G06T 11/001; G10L 21/10

(57) ABSTRACT

Provided is an apparatus for automatically classifying an input sound source according to a preset criterion and are an apparatus and method for automatically classifying a sound source according to a set criterion by using deep learning. The apparatus for classifying a sound source includes a processor and a memory connected to the processor and storing a deep learning algorithm and original sound data, wherein the memory stores program instructions executable by the processor to generate n pieces of image data corresponding to the original sound data according to a preset method, generate training image data corresponding to the original sound data by using the n pieces of image data, train the deep learning algorithm by using the training image data, and classify target sound data according to a preset criterion by using the deep learning algorithm, wherein the n is a natural number greater than or equal to 2.

### TECHNICAL FIELD

The disclosure relates to an apparatus for automatically classifying an input sound source according to a preset criterion, and more particularly, to an apparatus and method for automatically classifying a sound source according to a set criterion by using deep learning.

### BACKGROUND ART

A deep learning algorithm, which has learned the similarity between pieces of data subject to automatic classification, may identify features of pieces of input data and classify the pieces of data into the same clusters. To increase the accuracy of automatic classification of data using deep learning algorithms, a large amount of deep learning training data is required. However, the amount of training data is often insufficient to increase accuracy.

To compensate for this, data augmentation methods that increase the amount of data have been studied. In particular, when data to be classified is image data, the amount of training data is increased through conversion methods, such as rotation or translation of an image, to augment training image data. The aforementioned method is a method that augments image data and thus cannot be used when the data to be classified is sound data.

Moreover, there are many technologies that automatically classify sound data using deep learning. However, technologies of the related art use only one type of data and cannot simultaneously use heterogeneous data.

### DISCLOSURE

### Technical Problem

The disclosure provides an apparatus and method for classifying a sound source, capable of augmenting sound data based on a building acoustics theory and improving classification accuracy by using a heterogenous data processing method.

### Technical Solution

According to an embodiment of the disclosure, an apparatus for classifying a sound source includes a processor and a memory connected to the processor and storing a deep learning algorithm and original sound data, wherein the memory stores program instructions executable by the processor to generate n pieces of image data corresponding to the original sound data according to a preset method, generate training image data corresponding to the original sound data by using the n pieces of image data, train the deep learning algorithm by using the training image data, and classify target sound data according to a preset criterion by using the deep learning algorithm, wherein the n is a natural number greater than or equal to 2.

### Advantageous Effects

According to the disclosure, the classification accuracy of a deep learning algorithm may be increased by augmenting training sound data based on building acoustics theory, and accordingly, sound data to be classified may be automatically and accurately classified.

### DESCRIPTION OF DRAWINGS

In order to fully understand the drawings referenced in the detailed description of the disclosure, a brief description of each drawing is provided.

FIG. 1 is a block diagram of a sound source classification apparatus according to an embodiment of the disclosure.

FIG. 2 is a diagram for describing a flowchart of operations of a sound source classification apparatus, according to an embodiment of the disclosure.

FIG. 3 is a diagram for describing an operation of converting sound data into first image data, according to an embodiment of the disclosure.

FIG. 4 is a diagram for describing an operation of converting sound data into second image data and third image data, according to an embodiment of the disclosure.

FIG. 5 is a diagram for describing an operation of converting first image data and third image data into training image data, according to an embodiment of the disclosure.

FIG. 6 is a flowchart for describing a sound source classification method according to another embodiment of the disclosure.

### BEST MODE

According to an embodiment of the disclosure, an apparatus for classifying a sound source includes a processor and a memory connected to the processor and storing a deep learning algorithm and original sound data, wherein the memory stores program instructions executable by the processor to generate n pieces of image data corresponding to the original sound data according to a preset method, generate training image data corresponding to the original sound data by using the n pieces of image data, train the deep learning algorithm by using the training image data, and classify target sound data according to a preset criterion by using the deep learning algorithm, wherein the n is a natural number greater than or equal to 2.

According to an embodiment, the memory may store the program instructions to further store a plurality of pieces of spatial impulse information, generate pre-processed sound data by combining the original sound data with the plurality of pieces of spatial impulse information, and generate n pieces of image data by using the pre-processed sound data.

According to an embodiment, the memory may store the program instructions to generate color information corresponding to an individual pixel of each of the n pieces of image data, and generate the training image data by using the color information, wherein the n pieces of image data may have a same resolution.

According to an embodiment, the color information may correspond to a representative color of a pixel corresponding to the color information, wherein the representative color may correspond to a single color.

According to an embodiment, the representative color may correspond to a largest value among red-green-blue (RGB) values included in the pixel.

According to an embodiment, a color of each pixel of the training image data may correspond to the representative color of a pixel corresponding to each of the n pieces of image data.

According to an embodiment, a color of a first pixel of the training image data may correspond to an average value of first-first color information to (n−1)-th color information, wherein the first-first color information may correspond to a representative color of a pixel corresponding to a position of the first pixel among pixels of the first image data, and the (n−1)-th color information may correspond to a representative color of a pixel corresponding to the position of the first pixel among pixels of n-th image data.

According to another embodiment of the disclosure, a method, performed by a sound source classification apparatus, of classifying a sound source using a deep learning algorithm includes generating n pieces of image data corresponding to original sound data stored in a memory provided according to a preset method, generating training image data corresponding to the original sound data by using the n pieces of image data, training the deep learning algorithm by using the training image data, and classifying target sound data according to a preset criterion by using the trained deep learning algorithm, wherein the n is a natural number greater than or equal to 2.

According to an embodiment, the generating of the n pieces of image data may include generating pre-processed sound data by combining the original sound data with spatial impulse information stored in the memory, and generating the n pieces of image data by using the pre-processed sound data.

According to an embodiment, the generating of the training image data may include generating color information corresponding to an individual pixel of each of the n pieces of image data, and generating the training image data by using the color information, wherein the n pieces of image data may have a same resolution.

According to an embodiment, the color information may correspond to a representative color of a pixel corresponding to the color information, wherein the representative color may correspond to a single color.

According to an embodiment, the representative color may correspond to a largest value among red-green-blue (RGB) values included in the pixel.

According to an embodiment, a color of each pixel of the training image data may correspond to the representative color of a pixel corresponding to each of the n pieces of image data.

According to an embodiment, a color of a first pixel of the training image data may correspond to an average value of first-first color information to (n−1)-th color information, wherein the first-first color information may correspond to a representative color of a pixel corresponding to a position of the first pixel among pixels of the first image data, and the (n−1)-th color information may correspond to a representative color of a pixel corresponding to the position of the first pixel among pixels of n-th image data.

### MODE FOR INVENTION

Embodiments according to the technical idea of the disclosure are provided to more fully explain the technical idea of the disclosure to those of ordinary skill in the art. The following embodiments may be modified in many different forms, and the scope of the technical idea of the disclosure is not limited to the following embodiments. Rather, these embodiments are provided so that the disclosure will be thorough and complete and will fully convey the spirit of the disclosure to those of ordinary skill in the art.

Although terms such as first and second are used herein to describe various members, areas, layers, regions and/or components, it is obvious that these members, parts, areas, layers, regions and/or components should not be limited by these terms. These terms do not imply any particular order, top or bottom, or superiority or inferiority and are used only to distinguish one member, area, region, or component from another member, area, region, or component. Accordingly, a first member, area, region, or component described in detail below may refer to a second member, area, region, or component without departing from the technical idea of the disclosure. For example, without departing from the scope of the disclosure, a first component may be referred to as a second component, and similarly, a second component may also be referred to as a first component.

Unless defined otherwise, all terms used herein, including technical terms and scientific terms, have the same meaning as commonly understood by those of ordinary skill in the art to which the concept of the disclosure belongs. In addition, commonly used terms, as defined in the dictionary, should be interpreted as having a meaning consistent with what they mean in the context of the related technology, and unless explicitly defined herein, the terms should not be interpreted in an excessively formal sense.

As used herein, a term ‘and/or’ includes each and every combination of one or more of mentioned elements.

Hereinafter, embodiments according to the technical idea of the disclosure will be described in detail with reference to the accompanying drawings.

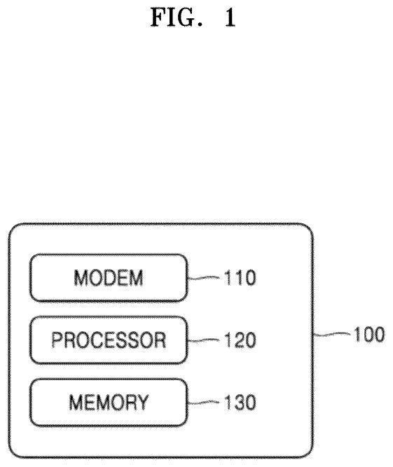

FIG. 1 is a block diagram of a sound source classification apparatus according to an embodiment of the disclosure.

According to an embodiment of the disclosure, a sound source classification apparatus 100 may classify data (hereinafter, referred to as ‘target sound data’) including sound information according to a preset criterion through a deep learning algorithm stored in a memory 130. For example, it is assumed that the target sound data is sound data including a cough sound of a user. In this case, the sound source classification apparatus 100 may classify, through the deep learning algorithm pre-stored in the memory 130, whether the target sound data is for a pneumonia patient or a normal person.

Referring to FIG. 1, according to an embodiment of the disclosure, the sound source classification apparatus 100 may include a modem 110, a processor 120, and the memory 130.

The modem 110 may be a communication modem that is electrically connected to other external apparatuses (not shown) to enable communication therebetween. In particular, the modem 110 may output the ‘target sound data’ received from the external apparatuses and/or ‘original sound data’ to the processor 120, and the processor 120 may store the target sound data and/or the original sound data in the memory 130.

In this case, the target sound data and the original sound data may be data including sound information. The target sound data may be an object to be classified by the sound source classification apparatus 100 by using the deep learning algorithm. The original sound data may be data for training the deep learning algorithm stored in the sound source classification apparatus 100. The original sound data may be labeled data.

The memory 130 is a component in which various pieces of information and program instructions for the operation of the sound source classification apparatus 100 are stored, and may be a storage apparatus such as a hard disk or a solid state drive (SSD). In particular, the memory 130 may store the target sound data and/or the original sound data input from the modem 110 under control by the processor 120. Also, the memory 130 may store the deep learning algorithm trained using the original sound data. That is, the deep learning algorithm may be trained using the original sound data stored in the memory 130. In this case, the original sound data is labeled data and may be data in which a sound and sound information (e.g., pneumonia or normal) are matched to each other.

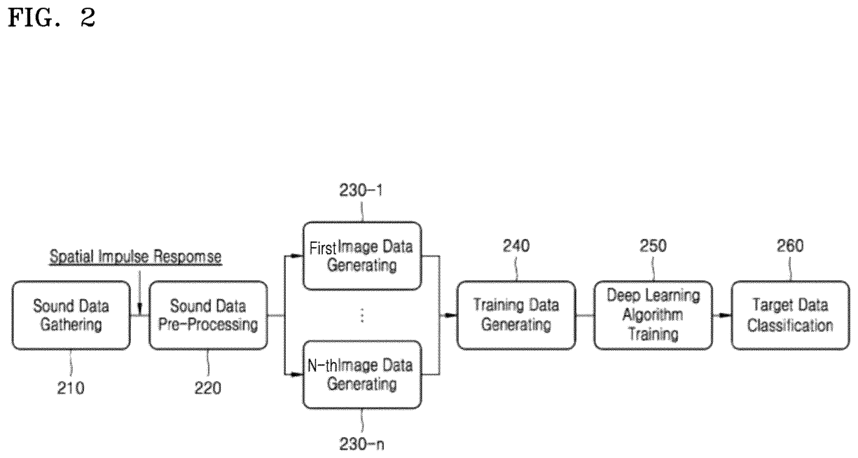

The processor 120 may classify the target sound data according to a preset criterion by using information stored in the memory 130, the deep learning algorithm, or other program instructions. Hereinafter, the operation of the processor 120 is described in detail with reference to FIGS. 2 to 5.

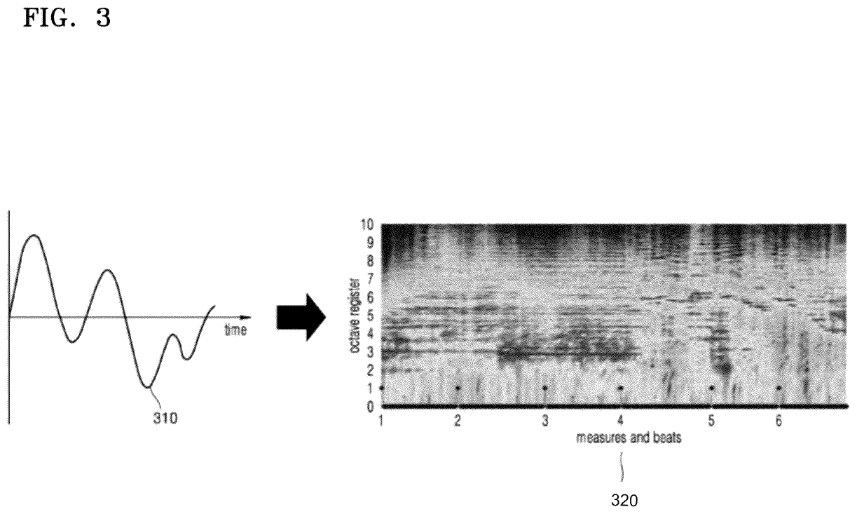

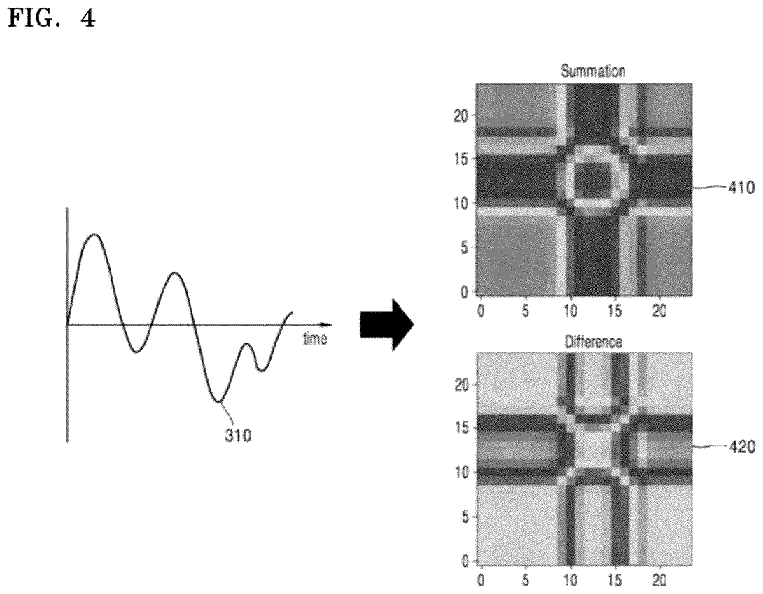

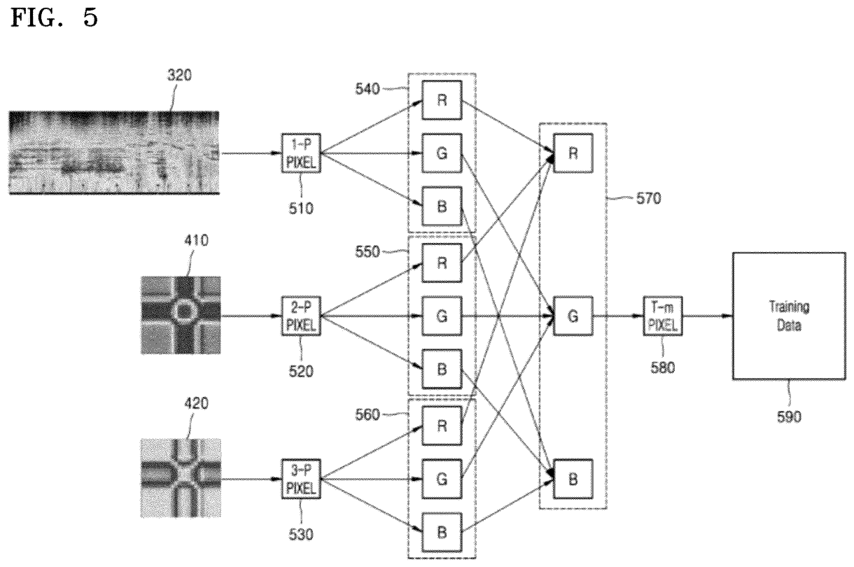

FIG. 2 is a diagram for describing a flowchart of operations of a sound source classification apparatus, according to an embodiment of the disclosure, FIG. 3 is a diagram for describing an operation of converting sound data into first image data, according to an embodiment of the disclosure, FIG. 4 is a diagram for describing an operation of converting sound data into second image data and third image data, according to an embodiment of the disclosure, and FIG. 5 is a diagram for describing an operation of converting first image data and third image data into training image data, according to an embodiment of the disclosure.

First, the processor 120 may collect original sound data (sound data gathering, 210). For example, the original sound data may be data about cough sounds. The original sound data may include data about cough sounds of normal people and data about cough sounds of pneumonia patients. The original sound data may be labeled data as described above.

Also, the processor 120 may generate pre-processed sound data by combining the original sound data with at least one piece of spatial impulse data (spatial impulse response) (sound data pre-processing, 220). In this case, the spatial impulse response is data pre-stored in the memory 130 and may be information about acoustic characteristics of an arbitrary space. That is, the spatial impulse response is data representing a change over time of sound pressure received in a room, and accordingly, acoustic characteristics of the space may be identified, and when the acoustic characteristics are convolutionally combined with another sound source, the acoustic characteristics of the corresponding space may be applied to the other sound source. Accordingly, the processor 120 may generate pre-processed sound data by convolutionally combining the original sound data with the spatial impulse response. The pre-processed sound data may be data obtained by applying, to the original sound data, characteristics of a space corresponding to the spatial impulse response. One piece of original sound data and m spatial impulse responses are convolutionally combined, n pieces of pre-processed sound data may be generated (provided that m is a natural number greater than or equal to 2).

Also, the processor 120 may convert the pre-processed sound data into n images according to a preset method (provided that n is a natural number) (230-1 and 230-2). There may be various methods by which the processor 120 converts pre-processed sound data about sound into images.

Referring to FIG. 3, a case in which the processor 120 converts pre-processed sound data 310 into a spectrogram 320 is illustrated (first image data generating, 230-1). A spectrogram is a tool for visualizing and identifying sound or waves and may be an image in which characteristics of a waveform and a spectrum are combined. Also, referring to FIG. 4, a case in which the processor 120 converts the pre-processed sound data 310 into a summation field image 410 and a difference field image 420 by using a Gramian angular field (GAF) technique is illustrated (n-th image data generating, 230-n). An operation by which the processor 120 converts the pre-processed sound data 310 into the spectrogram 320, the summation field image 410, the difference field image 420, or the like is almost identical to the previously provided description, and thus, a detailed description thereof is not provided.

Referring back to FIG. 2, the processor 120 may generate training image data by combining n pieces of image data according to a preset method (training data generation, 240). Hereinafter, an embodiment in which the processor 120 generates the training image data is described with reference to FIG. 5.

Referring to FIG. 5, an operation by which the processor 120 generates a single piece of training image data by using three pieces of image data is illustrated. In this case, the three pieces of image data may be the spectrogram 320, the summation field image 410, and the difference field image 420.

In this regard, the three pieces of image data may have the same resolution. Also, a resolution of training image data 590 may be the same as the resolution of the three pieces of image data 320, 410, and 420.

Alternatively, when the three pieces of image data 320, 410, and 420 have different resolutions, the resolution of the training image data 590 may be implemented with a resolution that may include all of the three pieces of image data 320, 410, and 420. That is, in this case, it is assumed that the resolution of the training image data 590 is x*y, a resolution of first image data 320 is x1*y1, a resolution of second image data 410 is x2*y2, and a resolution of third image data 420 is x3*y3. In this regard, when the largest value among x1, x2, and x3 is x2 and the largest value among y1, y2, and y3 is y1, x*y will be x2*y1.

Hereinafter, it is assumed that resolutions of the three pieces of image data 320, 410, and 420 and the training image data are all the same. First, the processor 120 may read color information about pixels 510 to 550 at the same position in each of the pieces of image data 320, 410, and 420.

For example, the processor 120 may read a first-first pixel 510 corresponding to a coordinate value (1,1) of the first image data. Also, the processor 120 may read a second-first pixel 520 corresponding to a coordinate value (1,1) of the second image data. Also, the processor 120 may read a third-first pixel 530 corresponding to a coordinate value (1,1) of the third image data.

In addition, the processor 120 may determine color information about the first-first pixel 510. For example, the processor 120 may read a red-green-blue (RGB) value 540 of the first-first pixel 510. Similarly, the processor 120 may read color information (e.g., RGB values) 550 and 560 about the second-first pixel 520 and the third-first pixel 530.

Also, the processor 120 may generate representative color information about the first-first pixel 510 by using the color information about the first-first pixel 510. For example, it is assumed that RGB values of the first-first pixel 510 are R1, C1, and B1, respectively. In this case, when the largest value among R1, G1, and B1 is R1, the processor 120 may generate the representative color information about the first-first pixel 510 as R1 (red). Similarly, the processor 120 may generate representative color information 570 about the second-first pixel 520 and the third-first pixel 530, respectively.

Also, the processor 120 may generate color information about a pixel 580 corresponding to a coordinate value (1,1) of the training image data 590 by using pieces of generated representative color information. For example, the processor 120 may generate the pieces of representative color information as color information about a pixel corresponding to the training image data 590, and when there are a plurality of pieces of information corresponding to the same color, the processor 120 may determine an average value thereof as a value of the color. That is, it is assumed that the representative color information about the first-first pixel 510 is ‘R1’, the representative color information about the second-first pixel 520 is ‘R2’, and the representative color information about the third-first pixel 530 is ‘G3’. In this case, the processor 120 may generate RGB values of the color information about the corresponding pixel of the training image data 590 as [(R1+R2)/2, G3, 0]. The processor 120 may generate color information about all pixels of the training image data 590 by using the aforementioned method.

Referring back to FIG. 2, the processor 120 may train a deep learning algorithm stored in the memory 130 by using the training image data 590 (deep learning algorithm training, 250). Original sound data is labeled data, pre-processed sound data obtained by combining an original sound source with a spatial impulse response is also labeled data, and first image data to n-th image data obtained by converting the pre-processed sound data into images are also labeled data and are data labeled with training image data generated through the first image data to the n-th image data. Accordingly, the deep learning algorithm may be trained with the labeled data (supervised learning). In this case, the deep learning algorithm may include a convolutional neural network (CNN).

Also, the processor 120 may classify target sound data according to a preset criterion (label) by using the trained deep learning algorithm (target data classification, 260). In this case, the processor 120 may process the target sound data as an input of the deep learning algorithm by processing the target sound data using the same method as the method of generating training image data. That is, the processor 120 may generate target image data by applying, to the target sound data, the aforementioned operation of converting original sound data into training image data and may input the target image data to the deep learning algorithm.

Accordingly, the processor 120 may determine, through the deep learning algorithm, whether the target sound data is abnormal (e.g., whether the target sound data matches a cough sound of a pneumonia patient).

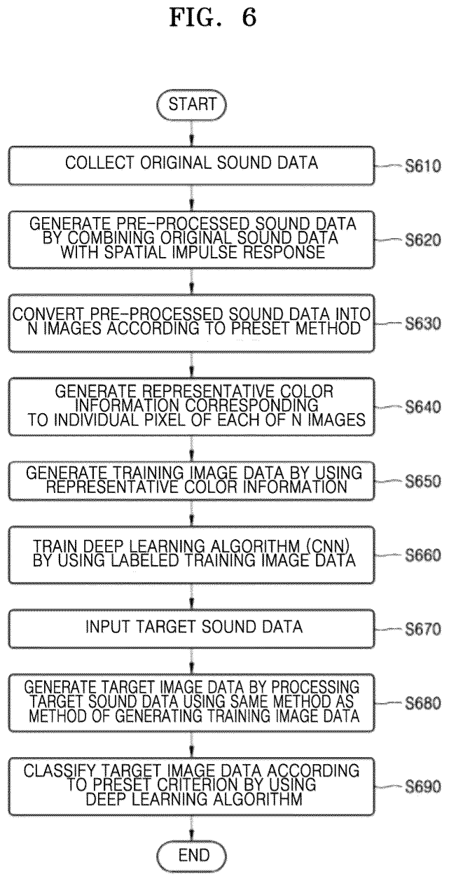

FIG. 6 is a flowchart for describing a sound source classification method according to another embodiment of the disclosure.

Operations to be described below may be operations performed by the processor 120 of the sound source classification apparatus 100 described above with reference to FIG. 2, but the operations will be collectively described as being performed by the sound source classification apparatus 100 for convenience of understanding and description.

In operation S610, the sound source classification apparatus 100 may collect original sound data. For example, the original sound data may be data about cough sounds. The original sound data may include data about cough sounds of normal people and data about cough sounds of pneumonia patients.

In operation S620, the sound source classification apparatus 100 may generate pre-processed sound data by combining the original sound data with at least one spatial impulse response. In this case, the spatial impulse response is data pre-stored in the memory 130 and may be information about acoustic characteristics of an arbitrary space. The sound source classification apparatus 100 may generate pre-processed sound data by convolutionally combining the original sound data with the spatial impulse response.

In operation S630, the sound source classification apparatus 100 may convert the pre-processed sound data into n pieces of image data according to a preset method. For example, the sound source classification apparatus 100 may convert the pre-processed sound data 310 into a spectrogram 320. As another example, the sound source classification apparatus 100 may also convert the pre-processed sound data 310 into a summation field image 410 and a difference field image 420 by using a GAF technique.

In operation S640, the sound source classification apparatus 100 may generate representative color information corresponding to an individual pixel of each of the n pieces of image data.

In operation S650, the sound source classification apparatus 100 may generate training image data by using the representative color information. An operation by which the sound source classification apparatus 100 generates a single piece of training image data by using the n pieces of image data may be the same as or similar to the operation described above in ‘240’ of FIG. 2.

In operation S660, the sound source classification apparatus 100 may train a deep learning algorithm (CNN) stored in the memory 130 by using labeled training image data.

When target sound data is input in operation S670, the sound source classification apparatus 100 may generate target image data by processing target sound data (operation S680) using the same method as the method of generating training image data (operations S610 to S650).

In operation S690, the sound source classification apparatus 100 may classify the target image data according to a preset criterion by using the deep learning algorithm. That is, the sound source classification apparatus 100 may input the target image data to the deep learning algorithm and classify whether the target sound data is normal.

As described above, by converting target sound data, which is field data, to correspond to training data or by converting training data to correspond to target sound data, subjects included in the target sound data may be automatically and accurately classified.

In the above, the disclosure has been described in detail with the embodiments, but is not limited to the above embodiments. Various modifications and changes may be made by those of ordinary skill in the art within the technical spirit and scope of the disclosure.

### INDUSTRIAL APPLICABILITY

According to an embodiment of the disclosure, an apparatus and method for classifying a sound source using deep learning are provided. Also, embodiments of the disclosure are applicable to the field of diagnosing diseases by classifying sound sources.

1. An apparatus for classifying a sound source, the apparatus comprising:
a processor; and
a memory connected to the processor and storing a deep learning algorithm and original sound data,
wherein the memory stores program instructions executable by the processor to generate n pieces of image data corresponding to the original sound data according to a preset method, generate training image data corresponding to the original sound data by using the n pieces of image data, train the deep learning algorithm by using the training image data, and classify target sound data according to a preset criterion by using the deep learning algorithm,
wherein the n is a natural number greater than or equal to 2.

2. The apparatus of claim 1, wherein the memory stores the program instructions to further store a plurality of pieces of spatial impulse information, generate pre-processed sound data by combining the original sound data with the plurality of pieces of spatial impulse information, and generate n pieces of image data by using the pre-processed sound data.

3. The apparatus of claim 1, wherein the memory stores the program instructions to generate color information corresponding to an individual pixel of each of the n pieces of image data, and generate the training image data by using the color information,
wherein the n pieces of image data have a same resolution.

4. The apparatus of claim 3, wherein the color information corresponds to a representative color of a pixel corresponding to the color information,
wherein the representative color corresponds to a single color.

5. The apparatus of claim 4, wherein the representative color corresponds to a largest value among red-green-blue (RGB) values included in the pixel.

6. The apparatus of claim 4, wherein a color of each pixel of the training image data corresponds to the representative color of a pixel corresponding to each of the n pieces of image data.

7. The apparatus of claim 6, wherein a color of a first pixel of the training image data corresponds to an average value of first-first color information to (n−1)-th color information,
wherein the first-first color information corresponds to a representative color of a pixel corresponding to a position of the first pixel among pixels of the first image data, and the (n−1)-th color information corresponds to a representative color of a pixel corresponding to the position of the first pixel among pixels of n-th image data.

8. A method, performed by a sound source classification apparatus, of classifying a sound source using a deep learning algorithm, the method comprising:
generating n pieces of image data corresponding to original sound data stored in a memory provided according to a preset method;
generating training image data corresponding to the original sound data by using the n pieces of image data;
training the deep learning algorithm by using the training image data; and
classifying target sound data according to a preset criterion by using the trained deep learning algorithm,
wherein the n is a natural number greater than or equal to 2.

9. The method of claim 8, wherein the generating of the n pieces of image data comprises:
generating pre-processed sound data by combining the original sound data with spatial impulse information stored in the memory; and
generating the n pieces of image data by using the pre-processed sound data.

10. The method of claim 8, wherein the generating of the training image data comprises:
generating color information corresponding to an individual pixel of each of the n pieces of image data; and
generating the training image data by using the color information,
wherein the n pieces of image data have a same resolution.

11. The method of claim 10, wherein the color information corresponds to a representative color of a pixel corresponding to the color information,
wherein the representative color corresponds to a single color.

12. The method of claim 11, wherein the representative color corresponds to a largest value among red-green-blue (RGB) values included in the pixel.

13. The method of claim 11, wherein a color of each pixel of the training image data corresponds to the representative color of a pixel corresponding to each of the n pieces of image data.

14. The method of claim 13, wherein a color of a first pixel of the training image data corresponds to an average value of first-first color information to (n−1)-th color information,
wherein the first-first color information corresponds to a representative color of a pixel corresponding to a position of the first pixel among pixels of the first image data, and the (n−1)-th color information corresponds to a representative color of a pixel corresponding to the position of the first pixel among pixels of n-th image data.
